(19) United States
(12) Patent Application Publication
(10) Pub. No.: US 2013/0267633 A1
(43) Pub. Date: Oct. 10, 2013

(54) Stabilized Polyolefins Having Increased Agrochemical and UV Resistance and Methods of Use

(71) Applicant: CYTEC TECHNOLOGY CORP., Wilmington, DE (US)

(72) Inventors: Iwan VULIC, Almelo (NL); Sari-Beth SAMUELS, Ramsey, NJ (US); Thomas STEELE, Milford, CT (US)

(73) Assignee: CYTEC TECHNOLOGY CORP., Wilmington, DE (US)

(21) Appl. No.: 13/856,112

(22) Filed: Apr. 3, 2013

(30) Foreign Application Priority Data
Apr. 4, 2012 (EP) 12163097.4

(51) Int. Cl. C08K 5/3492

(52) U.S. Cl. CPC C08K 5/3492
USPC 524/100

(57) ABSTRACT

Polyolefin thin films having a stabilizing amount of a stabilizer composition including:
i) at least one o-hydroxyphenyl triazine ultraviolet light absorber (I);
ii) at least one ultraviolet light stabilizer selected from tetramethyl-4-piperidinyl compounds (II) according to Formula II

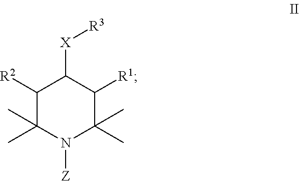

and
iii) at least one light stabilizer (III) chosen from hindered amine light stabilizers (HALS) different from compounds of formula II are provided herein, along with methods for stabilizing and/or using same, wherein the polyolefins have increased resistance against the degradative effects due to exposure to agrochemicals and/or UV light.

### CROSS-REFERENCE To RELATED APPLICATIONS

This application claims priority benefit of European Application No. 12163097.4, filed Apr. 4, 2012, which is incorporated herein by reference in its entirety.

### BACKGROUND OF THE INVENTION

1. Field of the Invention

The present invention generally relates to stabilized polyolefins. More particularly, the present invention relates to stabilized polyolefins for use in plasticulture, which are resistant to degradation due to the effects of photo and thermal oxidation (such as from UV light), and/or from the use of agrochemicals.

2. Description of Related Art

The prior art is replete with examples of various stabilizer compositions useful as additives for stabilizing polymer articles against long term exposure to light and heat. For example, EP 0 200 190 discloses stabilizer compositions containing a combination of hindered amine light stabilizer (HALS) and tris-aryl triazine and their use for stabilizing polymer films. EP 1 500 675 (related to EP 1 080 147 and WO 99/57189) discloses the synergistic effect of a light stabilization additive blend having an ortho-hydroxy tris-aryl triazine light absorber; and an oliogomeric, polymeric, or high molecular weight HALS, wherein the HALS has a molecular weight of at least 500, and wherein the weight ratio of HALS to triazine is from 3:1 to 20:1; and of polymeric (e.g., polyolefin) articles including same. WO 2005/047384 discloses stabilizer compositions similar to those in EP 1 500 675, but which additionally contain a hydroxybenzophenone. Such stabilizer compositions have been used with some success in plasticulture, which material degrades in a few months when used outdoors unless it contains appropriate light stabilization additives. These stabilizer compositions typically include high molecular weight or oligomeric HALS rather than low molecular weight HALS because HALS of low molecular weight are believed to bloom and migrate out of such plasticulture materials, thereby providing low stability.

The term “plasticulture” refers to the use of plastic materials in agricultural applications, which include greenhouse films, mulch films, row coverings, silage stretch films, silage sheets/bags, soil fumigation film, irrigation drip tape/tubing, nettings, nursery pots, non-woven fabrics, twines, high and low tunnels (polytunnels), and hydroponics. The materials themselves are typically referred to as “ag plastics” or in the case of films, “ag films.”

Such materials are mostly made of polyolefins, such as polyethylene or copolymers of ethylene, which are susceptible to photo and thermal oxidation as from UV light. This degradation results in dramatic loss of physical, mechanical, and optical properties in a short period. Therefore, to extend their service life, all ag plastics typically contain light and thermal stabilizers.

The stabilization of agricultural plastics and films is still the challenging target of the plasticulture industry. There are many inherent and environmental factors that may affect the service life of ag films. Among them are agrochemicals that can deactivate the UV stabilizing system and significantly reduce the service life of the product. The prodegradant effect of these pesticides on the films has been clearly demonstrated by Rull and Marin (2007).

Several attempts have been described to increase the stabilization of agricultural films used as greenhouse film covers, so that they can last longer in service. For example, it has been reported that the addition of metal oxides, salts or hydroxides enhances the stability of films that are exposed to pesticides. However the addition of such compounds, e.g. zinc oxide, imparts a milky or hazy appearance of the films and reduced transparency, which has an adverse effect on the light transmission into the greenhouse.

For example, U.S. Patent Publication No 2006/0141207 describes transparent polyolefin films for agricultural applications such as greenhouse films, containing a mixture of a triazine based UV absorber and a sterically hindered amine light stabilizer (HALS). WO 2007/088114 discloses the incorporation of tertiary amines having a molecular weight above 400 into greenhouse films improves the stability of such films when they are exposed to a sulphur-based pesticide treatment which is common practice in greenhouse applications.

Additionally, the main trends in plasticulture markets currently include aminoether (NOR) HALS combined with UV absorbers, or nickel quenchers combined with HALS and UV absorbers (see Vitalei et al. (2009), Plasticulture trends and light stabilization solutions: A comparative study of NOR technology+UVA and nickel quencher+HALS+UVA, Plasticulture vol. 8, No. 128, pp. 46-63), or HALS NOW (see Zäh et al, (2010), Aminoether HALS technology for agricultural films: The evolution continues, Plasticulture vol. 8, No. 129, pp. 6-21). However, it has been recognized that such products are not right for every cultivation condition as there are numerous parameters to take into account (see Galfré et al. (2010), New cost efficient & agrochemicals resistant light stabilizer class: How to develop a new light stabilizer for agricultural films, Plasticulture vol. 8, No. 129, pp. 46-67). Furthermore, these products are expensive and sometimes impart a brownish color to the ag films, which may be undesireable.

Accordingly, there is still a need for custom stabilizing compositions for use in plasticulture products such as polyolefin films for greenhouse applications, which would meet various performance criteria including better light and thermal stability, especially in the presence of agrochemicals such as pesticides, insecticides, and fumigants, and which would provide greater service life. Such products would find rapid acceptance in the industry.

### SUMMARY OF THE INVENTION

Applicants have surprisingly found that a combination of specific triazine based UV absorbers, HALS, and a specific type of tetramethyl-4-piperidinyl compounds as described herein increases the stability of polyolefin thin films exposed to agrochemicals such as pesticides, insecticides, fumigants, and soil disinfectants for agricultural applications, so that these films can be used for a longer period of time and not prematurely degrade to these effects.

The present invention therefore relates to methods for stabilizing polyolefin thin films against degradation in the presence of agrochemicals by incorporating into the polyolefin thin film a stabilizer composition having
i) at least one o-hydroxyphenyl triazine ultraviolet light absorber (I) selected from 2-(2′-hydroxyphenyl)-1,3,5-triazine compounds according to Formula I:

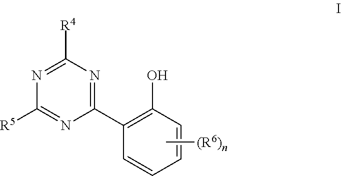

wherein:

each of R⁴ and R⁵ is, independently, chosen from C₆₋₁₀ aryl; or C₆₋₁₀ aryl substituted by one to three of: hydroxyl, halogen, C₁₋₁₂ hydrocarbyl, C₁₋₁₂ alkoxy, C₁₋₁₂ alkoxyester, C₂₋₁₂ alkanoyl, phenyl or by phenyl substituted by one to three of: hydroxyl, halogen, C₁₋₁₂ hydrocarbyl, C₁₋₁₂ alkoxy, C₁₋₁₂ alkoxyester, and C₂₋₁₂ alkanoyl, or by mixtures thereof; or mono- or di-C₁₋₁₂ hydrocarbyl-substituted amino; or C₂₋₁₂ alkanoyl; or C₁₋₁₂ alkyl; or C₁₋₁₂ alkoxy;

n is from 0 to 4; and

R⁶ is a substituent that is the same or different, at from 0 to 4 positions of the 2-hydroxyphenyl portion of Formula I, and is independently chosen from hydroxyl, halogen, C₁₋₁₂ hydrocarbyl, C₁₋₁₂ alkoxy, C₁₋₁₂ alkoxyester, C₂₋₁₂ alkanoyl and phenyl;
ii) at least one ultraviolet light stabilizer selected from tetramethyl-4-piperidinyl compounds (II) according to Formula II

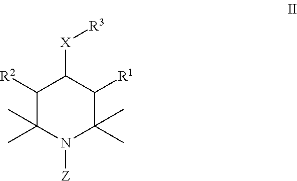

wherein:

X represents a bridging group selected from the group of —O—C(═O)—, —CR′₂—C(═O)—, —CR′₂—C(═O)—NR′—, —NR′—C(═O)—, —C(═O)—NR′—, —O—, —NR′— or —C(═O)— where each R′, independently, represents H or C₁₋₂₀ hydrocarbyl,

Z represents H, —R, —C(═O)—R or —OR where R is a C₁₋₂₀ hydrocarbyl, said hydrocarbyl being optionally substituted with one or more hydroxyl, C₁₋₃₀ alkoxy or C₂₋₃₀ alkanoyl,

R³ is a C₆₋₃₀ hydrocarbyl, and

each of R¹ and R² is, independently, chosen from H and C₁-C₆ alkyl; and
iii) at least one light stabilizer (III) chosen from hindered amine light stabilizers (HALS) different from compound of formula II.

The present invention further relates to polyolefin thin films comprising a stabilizer composition comprising
i) at least one o-hydroxyphenyl triazine ultraviolet light absorber (I) selected from 2-(2′-hydroxyphenyl)-1,3,5-triazine compounds according to Formula I:

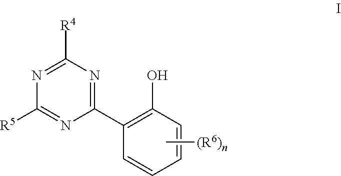

wherein:

each of R⁴ and R⁵ is, independently, chosen from C₆₋₁₀ aryl; or C₆₋₁₀ aryl substituted by one to three of: hydroxyl, halogen, C₁₋₁₂ hydrocarbyl, C₁₋₁₂ alkoxy, C₁₋₁₂ alkoxyester, C₂₋₁₂ alkanoyl, phenyl or by phenyl substituted by one to three of: hydroxyl, halogen, C₁₋₁₂ hydrocarbyl, C₁₋₁₂ alkoxy, C₁₋₁₂ alkoxyester, and C₂₋₁₂ alkanoyl, or by mixtures thereof; or mono- or di-C₁₋₁₂ hydrocarbyl-substituted amino; or C₂₋₁₂ alkanoyl; or C₁₋₁₂ alkyl; or C₁₋₁₂ alkoxy;

n is from 0 to 4; and

R⁶ is a substituent that is the same or different, at from 0 to 4 positions of the 2-hydroxyphenyl portion of Formula I, and is independently chosen from hydroxyl, halogen, C₁₋₁₂ hydrocarbyl, C₁₋₁₂ alkoxy, C₁₋₁₂ alkoxyester, C₂₋₁₂ alkanoyl and phenyl; and
ii) at least one ultraviolet light stabilizer selected from tetramethyl-4-piperidinyl compounds (II) according to Formula II

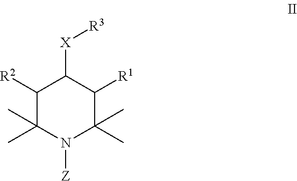

wherein:

X represents a bridging group selected from the group of —O—C(═O)—, —CR′₂—C(═O)—, —CR′₂—C(═O)—NR′—, —NR′—C(═O)—, —C(═O)—NR′—, —O—, —NR′— or —C(═O)— where each R′, independently, represents H or C₁₋₂₀ hydrocarbyl,

Z represents H, —R, —C(═O)—R or —OR where R is a C₁₋₂₀ hydrocarbyl, said hydrocarbyl being optionally substituted with one or more hydroxyl, C₁₋₃₀ alkoxy or C₂₋₃₀ alkanoyl,

R³ is a C₆₋₃₀ hydrocarbyl, and

each of R¹ and R² is, independently, chosen from H and C₁-C₆ alkyl; and
iii) at least one light stabilizer (III) chosen from hindered amine light stabilizers (HALS) different from compound of formula II.

These and other objects, features and advantages of this invention will become apparent from the following detailed description of the various aspects of the invention taken in conjunction with the accompanying Examples.

### DETAILED DESCRIPTION OF CERTAIN EMBODIMENTS OF THE INVENTION

As summarized above, the inventors have surprisingly discovered that the addition of certain low molecular weight HALS to polyolefin thin film stabilizing additives containing an oligomeric, polymeric, or high molecular weight HALS and an ortho-hydroxy tris-aryl triazine UV light absorber provide increased agrochemical and UV resistance to said films. The addition of these low molecular weight HALS to such films was previously thought unworkable because it was believed that these compounds would cause blooming, would migrate out of the film, would have low solubility, and/or would provide low stability. As discussed more fully below, the present invention shows that this is not the case and that the use of such low molecular weight UV light stabilizers in combination with ultraviolet light stabilizers of (I) and (III) provide a surprising synergistic effect on the longevity of such films.

Accordingly, in one aspect the invention provides polyolefin thin films having a stabilizing amount of a stabilizer composition including:
i) at least one o-hydroxyphenyl triazine ultraviolet light absorber (I) as summarized herein;
ii) at least one ultraviolet light stabilizer selected from tetramethyl-4-piperidinyl compounds (II) as summarized herein; and
iii) at least one light stabilizer (III) chosen from hindered amine light stabilizers (HALS) different from compounds of formula II, as summarized herein, wherein the polyolefins have increased resistance to the degradative effects from exposure to agrochemicals and/or UV light.

By hydrocarbyl is meant in the present description a univalent radical derived from a hydrocarbon, i.e. compounds comprising carbon and hydrogen, and include aliphatic hydrocarbons such as alkyls, alkenyls, as well as cyclic compounds, such as alicyclic compounds and aryl compounds, as well as combinations thereof. By substituted is meant to designate in the present invention, hydrocarbyl groups wherein one or more hydrogen or one or more carbon atom are replaced by another atom or group. By optionally substituted is meant to designate both unsubstituted and substituted moieties.

The polyolefin films according to the invention are comprised of at least one homo- or copolymer based on at least one acyclic olefin, such as ethylene and propylene. Suitable homopolymers include homopolymers of ethylene and propylene. Suitable copolymers include copolymers of ethylene with other acyclic olefins such as propylene, butenes (n- and isobutylene), pentenes (such as 1-pentene and isopentene), hexenes (e.g. 4-methyl-1-pentene, 1-hexene) octenes (e.g. 1-octene), etc. and/or other copolymerizable monomers such at vinyl acetate, ethyl acrylate, n-butyl acrylate and methyl acrylate. The preferred polyolefins do not contain cycloolefins. Mixtures of different polyolefin homopolymers and/or copolymers can be used. The polyolefins can be produced by polymerization of one or more acyclic olefin using Ziegler Natta catalysts, Chromium oxide catalysts, single site or metallocene catalysts. The polymers may be made by slurry, gas phase, fluid bed gas phase, solution processes or by high pressure polymerization or combinations thereof.

Preferred polyolefin films are films made of polyethylene, such as low density polyethylene (LDPE), linear low density polyethylene (LLDPE), polyethylene obtained with metallocene catalysts (mPE) and high density polyethylene (HDPE), polypropylene and ethylene based copolymers, in particular ethylene-vinylacetate copolymers (EVA), ethylene ethylacrylate copolymers (EEA), ethylene butylacrylate copolymers (EBA) and ethylene methacrylate copolymers (EMA), as well as blends thereof. Particularly preferred are films manufactured of LDPE, of LLDPE, of mPE and blends thereof, of EVA and their blends with LDPE and/or LLDPE, of EBA and their blends with LDPE and/or LLDPE.

By polyolefin films is meant to designate in the present invention both monolayer and multilayer films. The polyolefin films may also be part of a multilayer film comprising one or more layers of a polyolefin film according to the invention and one or more layer of other types of film, such as for example a polyamide film.

The polyolefin thin films according to the invention film usually have a thickness of 1 to 350 micron. They preferably have a thickness of at least 10 microns, more preferably of at least 12 microns. The polyolefin films preferably have a thickness of at most 300 microns, and most preferably, a maximum thickness of 250 microns. The thickness of the films is generally measured according to ISO 4591 and ISO 4593.

In case the polyolefin films according to the invention are used as greenhouse films or tunnel films or solarization films, the polyolefin films are preferably transparent, in particular having a total visible light transmission of at least 80% as measured according to the EN 2155-5 test method. The films according to the invention more preferably have a total visible light transmission of at least 86%.

The ultraviolet light absorber selected from 2-(2′-hydroxyphenyl)-1,3,5-triazine compounds (I) according to Formula I is preferably a compound wherein each of R⁴ and R⁵ is, independently, chosen from C₆₋₁₀ aryl or C₆₋₁₀ aryl substituted by one to three of: hydroxyl, C₁₋₁₂ hydrocarbyl, or by phenyl or by mixtures thereof; n is 1; and R⁶ is a substituent chosen from C₁₋₁₂ alkoxy.

Suitable triazine-type ultraviolet light absorbers (I) for use with the invention include those selected from 4,6-bis-(2,4-dimethylphenyl)-2-(2-hydroxy-4-octyloxyphenyl)-s-triazine (CYASORB®UV-1164 light absorber available from Cytec Industries Inc.); 4,6-bis-(2,4-dimethylphenyl)-2-(2,4-dihydroxyphenyl)-s-triazine; 2,4-bis(2,4-dihydroxyphenyl)-6-(4-chlorophenyl)-s-triazine; 2,4-bis[2-hydroxy-4-(2-hydroxy-ethoxy)phenyl]-6-(4-chlorophenyl)-s-triazine; 2,4-bis[2-hydroxy-4-(2-hydroxy-4-(2-hydroxy-ethoxy)phenyl]-6-(2,4-dimethylphenyl)-s-triazine; 2,4-bis[2-hydroxy-4-(2-hydroxyethoxy)phenyl]-6-(4-bromophenyl)-s-triazine; 2,4-bis[2-hydroxy-4-(2-acetoxyethoxy)phenyl]-6-(4-chlorophenyl)-s-triazine; 2,4-bis(2,4-dihydroxyphenyl)-6-(2,4-dimethylphenyl)-s-triazine; 2,4-bis(4-biphenylyl)-6-[2-hydroxy-4-[(octyloxycarbonyl)ethylideneoxy]phenyl]-s-triazine; 2,4-bis(4-biphenylyl)-6-[2-hydroxy-4-(2-ethylhexyloxy)phenyl]-s-triazine; 2-phenyl-4-[2-hydroxy-4-(3-sec-butyloxy-2-hydroxypropyloxy)phenyl]-6-[2-hydroxy-4-(3-sec-amyloxy-2-hydroxypropyloxy)phenyl]-s-triazine; 2,4-bis(2,4-dimethylphenyl)-6-[2-hydroxy-4(-3-benzyloxy-2-hydroxypropyloxy)phenyl]-s-triazine; 2,4-bis(2-hydroxy-4-n-butyloxyphenyl)-6-(2,4-di-n-butyloxyphenyl)-s-triazine; 2,4-bis(2,4-dimethylphenyl)-6-[2-hydroxy-4-(3-nonyloxy-2-hydroxypropyloxy)-5-α-cumylphenyl]-s-triazine; 2,4,6-tris(2-hydroxy-4-isooctyloxycarbonyliso-propylideneoxy-phenyl)-s-triazine; 2,4-bis(2,4-dimethylphenyl)-6-(2-hydroxy-4-hexyloxy-5-α-cumylphenyl)-s-triazine; 2-(2,4,6-trimethylphenyl)-4,6-bis[2-hydroxy-4-(3-butyloxy-2-hydroxypropyloxy)phenyl]-s-triazine; 2,4,6-tris[2-hydroxy-4-(3-sec-butyloxy-2-hydroxypropyloxy)-phenyl]-s-triazine; 4,6-bis-(2,4-dimethylphenyl)-2-(2-hydroxy-4-(3-dodecyloxy-2-hydroxypropoxy)phenyl)-s-triazine; 4,6-bis-(2,4-dimethylphenyl)-2-(2-hydroxy-4-(3-tridecyloxy-2-hydroxypropoxy)phenyl)-s-triazine; 4,6-bis-(2,4-dimethylphenyl)-2-(2-hydroxy-4(3-(2-ethylhexyloxy)-2-hydroxypropoxy)-phenyl)-s-triazine; 4,6-diphenyl-2-(4-hexyloxy-2-hydroxyphenyl)-s-triazine; 2-(4,6-diphenyl-1,3,5-triazin-2-yl)-5-[2-(2-ethylhexanoyloxy)ethoxy]phenol; 2,4,6-tris(2-hydroxy-4-octyloxyphenyl)-1,3,5-triazine; propanoic acid, 2,2′,2″-[1,3,5-triazine-2,4,6-triyltris[(3-hydroxy-4,1-phenylene)oxy]]tris-1,1′,1″-trioctyl ester; propanoic acid, 2-[4-[4,6-bis([1,1′-biphenyl]-4-yl)-1,3,5-triazin-2yl]-3-hydroxyphenoxy]-isooctyl ester; 2,4-bis(4-biphenylyl)-6-[2-hydroxy-4-(2-ethylhexyloxy)phenyl]-1,3,5-triazine; and combinations thereof.

Preferred triazine-type ultraviolet light absorbers (I) are 4,6-bis-(2,4-dimethylphenyl)-2-(2-hydroxy-4-octyloxyphenyl)-s-triazine (commercialized as CYASORB®UV-1164 light absorber); 4,6-diphenyl-2-(4-hexyloxy-2-hydroxyphenyl)-s-triazine (commercialized as TINUVIN®1577); 4,6-bis-(2,4-dimethylphenyl)-2-(2-hydroxy-4-(3-dodecyloxy-2-hydroxypropoxy)phenyl)-s-triazine and 4,6-bis-(2,4-dimethylphenyl)-2-(2-hydroxy-4-(3-tridecyloxy-2-hydroxypropoxy)phenyl)-s-triazine and mixtures thereof (commercialized as TINUVIN®400-2); propanoic acid, 2-[4-[4,6-bis([1,1′-biphenyl]-4-yl)-1,3,5-triazin-2yl]-3-hydroxyphenoxy]-isooctyl ester (commercialized as TINUVIN®479); UV-absorber TINUVIN®1600; and 2,4-bis(4-biphenylyl)-6-[2-hydroxy-4-(2-ethylhexyloxy)phenyl]-1,3,5-triazine; as well as mixtures thereof.

A particularly preferred ultraviolet light absorber (I) is 4,6-bis-(2,4-dimethylphenyl)-2-(2-hydroxy-4-octyloxyphenyl)-s-triazine (which is commercialized as CYASORB®UV-1164 light absorber by Cytec Industries Inc.).

The amount of ultraviolet light absorber (I) present in the polyolefin is generally from 0.01 to 0.6% by weight. Preferably the amount of ultraviolet light absorber (I) is at least 0.05% by weight, more preferably at least 0.1% by weight. The amount of ultraviolet light absorber (I) preferably does not exceed 0.5% by weight, more preferably does not exceed 0.4% by weight, most preferably does not exceed 0.35% by weight.

In the tetramethyl-4-piperidinyl compounds according to Formula II, X is preferably —O— or —O—C(═O)—. The hindered amine ultraviolet light stabilizer selected from tetramethyl-4-piperidinyl compounds (II) is more preferably a compound according to Formula II wherein X is —O—C(═O)— according to formula IIa

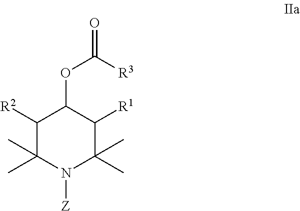

wherein R¹, R², R³ and Z are as defined above.

In the tetramethyl-4-piperidinyl compounds according to Formula II and IIa:

Z is preferably H, a C₁₋₆ alkyl or —OR where R is a C₁₋₁₀ alkyl optionally substituted with hydroxyl, C₁₋₂₂alkoxy or C₂₋₂₂ alkanoyl; Z is more preferably H, CH₃ or —O—CH₂—C(OH)(CH₃)—CH₃; Z is most preferably H or CH₃.

In the tetramethyl-4-piperidinyl compounds according to Formula II and IIa, R³ is preferably a C₆₋₃₀ alkyl or C₆₋₃₀ alkenyl, more preferably a C₁₂₋₂₂ alkyl or C₁₂₋₂₂ alkenyl;

In the tetramethyl-4-piperidinyl compounds according to Formula II and IIa, R¹ and R² are preferably H.

The ultraviolet light stabilizer selected from tetramethyl-4-piperidinyl compounds (II) is most preferably a compound according to formula IIb or formula IIc

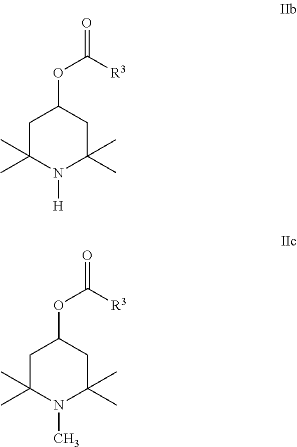

wherein R³ is a C₆₋₃₀ alkyl or C₆₋₃₀ alkenyl, more preferably a C₁₂₋₂₂ alkyl or C₁₂₋₂₂ alkenyl.

The hindered amine-type ultraviolet light stabilizer (II) is preferably selected from those of formula II, IIa, IIb and/or IIc wherein R³ is a C₁₆₋₁₈ alkyl or alkenyl.

The ultraviolet light stabilizer (II) is preferably selected from the fatty acid esters of 2,2,6,6-tetramethylpiperidinol, 1,2,2,6,6-pentamethylpiperidinol and 1-alkoxy-2,2,6,6-tetramethylpiperidinols, wherein the alkoxy group contains from 1 to 8 carbon atoms and is optionally substituted with a hydroxyl group, a C₁₋₂₂ alkoxy group or a C₂₋₂₂ alkanoyl group, especially 1-(2-hydroxy-methylpropoxy)-2,2,6,6-tetramethylpiperidinol. Commercial fatty acids usually contain mixtures of saturated and unsaturated fatty acids. Preferred are C₁₂₋₂₂ alkyl and/or alkenyl fatty acids, more specifically C₁₂₋₂₂ alkyl and C₁₆ and/or C₁₈ alkenyl fatty acids.

Suitable tetramethyl-4-piperidinyl compounds (II) are 2,2,6,6-tetramethylpiperidin-4-yl-docosanoate; 2,2,6,6-tetramethylpiperidin-4-yl-heneicosanoate; 2,2,6,6-tetramethylpiperidin-4-yl-eicosanoate; 2,2,6,6-tetramethylpiperidin-4-yl-octadecanoate; 2,2,6,6-tetramethylpiperidin-4-yl-hexadecanoate; 2,2,6,6-tetramethylpiperidin-4-yl-tetradecanoate; 2,2,6,6-tetramethylpiperidin-4-yl-dodecanoate; 1,2,2,6,6-pentamethylpiperidin-4-yl-docosanoate; 1,2,2,6,6-pentamethylpiperidin-4-yl-heneicosanoate; 1,2,2,6,6-pentamethylpiperidin-4-yl-eicosanoate; 1,2,2,6,6-pentamethylpiperidin-4-yl-octadecanoate; 1,2,2,6,6-pentamethylpiperidin-4-yl-hexadecanoate; 1,2,2,6,6-pentamethylpiperidin-4-yl-tetradecanoate; 1,2,2,6,6-pentamethylpiperidin-4-yl-dodecanoate; 1-hexyloxy,2,2,6,6-tetramethylpiperidin-4-yl-docosanoate; 1-propoxy,2,2,6,6-tetramethylpiperidin-4-yl-docosanoate; 1-cyclohexyloxy,2,2,6,6-tetramethylpiperidin-4-yl-docosanoate; 1-octyloxy,2,2,6,6-tetramethylpiperidin-4-yl-docosanoate; 1-hexyloxy,2,2,6,6-tetramethylpiperidin-4-yl-eicosanoate; 1-propoxy,2,2,6,6-tetramethylpiperidin-4-yl-eicosanoate; 1-cyclohexyloxy,2,2,6,6-tetramethylpiperidin-4-yl-eicosanoate; 1-octyloxy,2,2,6,6-tetramethylpiperidin-4-yl-eicosanoate; 1-hexyloxy,2,2,6,6-tetramethylpiperidin-4-yl-octadecanoate; 1-propoxy,2,2,6,6-tetramethylpiperidin-4-yl-octadecanoate; 1-cyclohexyloxy,2,2,6,6-tetramethylpiperidin-4-yl-octadecanoate; 1-octyloxy,2,2,6,6-tetramethylpiperidin-4-yl-octadecanoate; 1-hexyloxy,2,2,6,6-tetramethylpiperidin-4-yl-hexadecanoate; 1-propoxy,2,2,6,6-tetramethylpiperidin-4-yl-hexadecanoate; 1-cyclohexyloxy,2,2,6,6-tetramethylpiperidin-4-yl-hexadecanoate; 1-octyloxy,2,2,6,6-tetramethylpiperidin-4-yl-hexadecanoate; 1-(2-hydroxy-2-methylpropoxy)-4-docosanoyloxy-2,2,6,6-tetramethylpiperidine; 1-(2-hydroxy-2-methylpropoxy)-4-eicosanoyloxy-2,2,6,6-tetramethylpiperidine; 1-(2-hydroxy-2-methylpropoxy)-4-octadecanoyloxy-2,2,6,6-tetramethylpiperidine; 1-(2-hydroxy-2-methylpropoxy)-4-hexadecanoyloxy-2,2,6,6-tetramethylpiperidine; 1-(4-docosanoyloxy-2,2,6,6-tetramethylpiperidin-1-yloxy)-2-docosanoyloxy-2-methylpropane; 1-(4-eicosanoyloxy-2,2,6,6-tetramethylpiperidin-1-yloxy)-2-eicosanoyloxy-2-methylpropane; 1-(4-octadecanoyloxy-2,2,6,6-tetramethylpiperidin-1-yloxy)-2-octadecanoyloxy-2-methylpropane; 1-(4-hexadecanoyloxy-2,2,6,6-tetramethylpiperidin-1-yloxy)-2-hexadecanoyloxy-2-methylpropane; 1-(2-methoxy-2-methylpropoxy)-4-docosanoyloxy-2,2,6,6-tetramethylpiperidine; 1-(2-propoxy-2-methylpropoxy)-4-docosanoyloxy-2,2,6,6-tetramethylpiperidine; 1-(2-hexyloxy-2-methylpropoxy)-4-docosanoyloxy-2,2,6,6-tetramethylpiperidine; 1-(2-cyclohexyloxy-2-methylpropoxy)-4-docosanoyloxy-2,2,6,6-tetramethylpiperidine; 1-(2-octyloxy-2-methylpropoxy)-4-docosanoyloxy-2,2,6,6-tetramethylpiperidine; 1-(2-hexadecyloxy-2-methylpropoxy)-4-docosanoyloxy-2,2,6,6-tetramethylpiperidine; 1-(2-octadecyloxy-2-methylpropoxy)-4-docosanoyloxy-2,2,6,6-tetramethylpiperidine; 1-(2-methoxy-2-methylpropoxy)-4-eicosanoyloxy-2,2,6,6-tetramethylpiperidine; 1-(2-propoxy-2-methylpropoxy)-4-eicosanoyloxy-2,2,6,6-tetramethylpiperidine; 1-(2-hexyloxy-2-methylpropoxy)-4-eicosanoyloxy-2,2,6,6-tetramethylpiperidine; 1-(2-cyclohexyloxy-2-methylpropoxy)-4-eicosanoyloxy-2,2,6,6-tetramethylpiperidine; 1-(2-octyloxy-2-methylpropoxy)-4-eicosanoyloxy-2,2,6,6-tetramethylpiperidine; 1-(2-hexadecyloxy-2-methylpropoxy)-4-eicosanoyloxy-2,2,6,6-tetramethylpiperidine; 1-(2-octadecyloxy-2-methylpropoxy)-4-eicosanoyloxy-2,2,6,6-tetramethylpiperidine; 1-(2-methoxy-2-methylpropoxy)-4-octadecanoyloxy-2,2,6,6-tetramethylpiperidine; 1-(2-propoxy-2-methylpropoxy)-4-octadecanoyloxy-2,2,6,6-tetramethylpiperidine; 1-(2-hexyloxy-2-methylpropoxy)-4-octadecanoyloxy-2,2,6,6-tetramethylpiperidine; 1-(2-cyclohexyloxy-2-methylpropoxy)-4-octadecanoyloxy-2,2,6,6-tetramethylpiperidine; 1-(2-octyloxy-2-methylpropoxy)-4-octadecanoyloxy-2,2,6,6-tetramethylpiperidine; 1-(2-hexadecyloxy-2-methylpropoxy)-4-octadecanoyloxy-2,2,6,6-tetramethylpiperidine; 1-(2-octadecyloxy-2-methylpropoxy)-4-octadecanoyloxy-2,2,6,6-tetramethylpiperidine; 1-(2-methoxy-2-methylpropoxy)-4-hexadecanoyloxy-2,2,6,6-tetramethylpiperidine; 1-(2-propoxy-2-methylpropoxy)-4-hexadecanoyloxy-2,2,6,6-tetramethylpiperidine; 1-(2-hexyloxy-2-methylpropoxy)-4-hexadecanoyloxy-2,2,6,6-tetramethylpiperidine; 1-(2-cyclohexyloxy-2-methylpropoxy)-4-hexadecanoyloxy-2,2,6,6-tetramethylpiperidine; 1-(2-octyloxy-2-methylpropoxy)-4-hexadecanoyloxy-2,2,6,6-tetramethylpiperidine; 1-(2-hexadecyloxy-2-methylpropoxy)-4-hexadecanoyloxy-2,2,6,6-tetramethylpiperidine; 1-(2-octadecyloxy-2-methylpropoxy)-4-hexadecanoyloxy-2,2,6,6-tetramethylpiperidine; 4-stearyloxy-1-octyloxy-2,2,6,6-tetramethylpiperidine; 4-hexadecyloxy-1-octyloxy-2,2,6,6-tetramethylpiperidine; and mixtures thereof.

Preferred tetramethyl-4-piperidinyl compounds (II) are 2,2,6,6-tetramethylpiperidin-4-yl-eicosanoate; 2,2,6,6-tetramethylpiperidin-4-yl-octadecanoate; 2,2,6,6-tetramethylpiperidin-4-yl-hexadecanoate; and mixture thereof; 1,2,2,6,6-pentamethylpiperidin-4-yl-eicosanoate; 1,2,2,6,6-pentamethylpiperidin-4-yl-octadecanoate; 1,2,2,6,6-pentamethylpiperidin-4-yl-hexadecanoate; and mixtures thereof; 1-(2-hydroxy-2-methylpropoxy)-4-eicosanoyloxy-2,2,6,6-tetramethylpiperidine; 1-(2-hydroxy-2-methylpropoxy)-4-octadecanoyloxy-2,2,6,6-tetramethylpiperidine; 1-(2-hydroxy-2-methylpropoxy)-4-hexadecanoyloxy-2,2,6,6-tetramethylpiperidine; and mixtures thereof; 1-(4-eicosanoyloxy-2,2,6,6-tetramethylpiperidin-1-yloxy)-2-eicosanoyloxy-2-methylpropane; 1-(4-octadecanoyloxy-2,2,6,6-tetramethylpiperidin-1-yloxy)-2-octadecanoyloxy-2-methylpropane; 1-(4-hexadecanoyloxy-2,2,6,6-tetramethylpiperidin-1-yloxy)-2-hexadecanoyloxy-2-methylpropane; and mixtures thereof; 1-(2-propoxy-2-methylpropoxy)-4-eicosanoyloxy-2,2,6,6-tetramethylpiperidine; 1-(2-hexyloxy-2-methylpropoxy)-4-eicosanoyloxy-2,2,6,6-tetramethylpiperidine; 1-(2-cyclohexyloxy-2-methylpropoxy)-4-eicosanoyloxy-2,2,6,6-tetramethylpiperidine; 1-(2-octyloxy-2-methylpropoxy)-4-eicosanoyloxy-2,2,6,6-tetramethylpiperidine; 1-(2-propoxy-2-methylpropoxy)-4-octadecanoyloxy-2,2,6,6-tetramethylpiperidine; 1-(2-hexyloxy-2-methylpropoxy)-4-octadecanoyloxy-2,2,6,6-tetramethylpiperidine; 1-(2-cyclohexyloxy-2-methylpropoxy)-4-octadecanoyloxy-2,2,6,6-tetramethylpiperidine; 1-(2-octyloxy-2-methylpropoxy)-4-octadecanoyloxy-2,2,6,6-tetramethylpiperidine; 1-(2-propoxy-2-methylpropoxy)-4-hexadecanoyloxy-2,2,6,6-tetramethylpiperidine; 1-(2-hexyloxy-2-methylpropoxy)-4-hexadecanoyloxy-2,2,6,6-tetramethylpiperidine; 1-(2-cyclohexyloxy-2-methylpropoxy)-4-hexadecanoyloxy-2,2,6,6-tetramethylpiperidine; 1-(2-octyloxy-2-methylpropoxy)-4-hexadecanoyloxy-2,2,6,6-tetramethylpiperidine; and mixtures thereof.

More preferred tetramethyl-4-piperidinyl compounds (II) are 2,2,6,6-tetramethylpiperidin-4-yl-octadecanoate; 2,2,6,6-tetramethylpiperidin-4-yl-hexadecanoate; and mixtures thereof; 1,2,2,6,6-pentamethylpiperidin-4-yl-octadecanoate; 1,2,2,6,6-pentamethylpiperidin-4-yl-hexadecanoate; and mixtures thereof; 1-(2-hydroxy-2-methylpropoxy)-4-eicosanoyloxy-2,2,6,6-tetramethylpiperidine; 1-(2-hydroxy-2-methylpropoxy)-4-octadecanoyloxy-2,2,6,6-tetramethylpiperidine; 1-(2-hydroxy-2-methylpropoxy)-4-hexadecanoyloxy-2,2,6,6-tetramethylpiperidine; 1-(4-octadecanoyloxy-2,2,6,6-tetramethylpiperidin-1-yloxy)-2-octadecanoyloxy-2-methylpropane; 1-(4-hexadecanoyloxy-2,2,6,6-tetramethylpiperidin-1-yloxy)-2-hexadecanoyloxy-2-methylpropane; 1-(2-hexyloxy-2-methylpropoxy)-4-octadecanoyloxy-2,2,6,6-tetramethylpiperidine; 1-(2-cyclohexyloxy-2-methylpropoxy)-4-octadecanoyloxy-2,2,6,6-tetramethylpiperidine; 1-(2-octyloxy-2-methylpropoxy)-4-octadecanoyloxy-2,2,6,6-tetramethylpiperidine; 1-(2-hexyloxy-2-methylpropoxy)-4-hexadecanoyloxy-2,2,6,6-tetramethylpiperidine; 1-(2-cyclohexyloxy-2-methylpropoxy)-4-hexadecanoyloxy-2,2,6,6-tetramethylpiperidine; 1-(2-octyloxy-2-methylpropoxy)-4-hexadecanoyloxy-2,2,6,6-tetramethylpiperidine; and mixtures thereof.

Most preferred tetramethyl-4-piperidinyl compounds (II) are 2,2,6,6-tetramethylpiperidin-4-yl-octadecanoate; 2,2,6,6-tetramethylpiperidin-4-yl-hexadecanoate; and mixtures thereof; 1,2,2,6,6-pentamethylpiperidin-4-yl-octadecanoate; 1,2,2,6,6-pentamethylpiperidin-4-yl-hexadecanoate; and mixtures thereof. Particularly preferred is the UV stabilizer commercialized as CYASORB®UV-3853 light stabilizer by Cytec Industries Inc., which predominantly contains a mixture of C₁₆₋₁₈ fatty acid esters of 2,2,6,6-tetramethylpiperidinol. While the commercialized form is typically referred to as CYASORB®UV-3853, any form of this product may be used in accordance with the present invention as described herein (e.g., UV-3853S (50% in LDPE carrier); UV-3853PE5 (50% in LDPE carrier); UV-3853PP4 (40% in PP carrier); and UV-3853PP5 (50% in PP carrier)).

The amount of ultraviolet light stabilizer selected from tetramethyl-4-piperidinyl compounds (II) present in the polyolefin film is generally from 0.02 to 0.9% by weight. Preferably the amount of ultraviolet light stabilizer (II) is at least 0.1% by weight, more preferably at least 0.3% by weight. The amount of ultraviolet light stabilizer (II) preferably does not exceed 0.8% by weight.

The ultraviolet light stabilizer (III) chosen from hindered amine light stabilizers (HALS) different from compound of formula (II) is preferably chosen from monomeric and oligomeric HALS having a number average molecular weight (Mn) of at least 900. In the present invention, by oligomeric HALS it is intended to designate compounds comprising at least 2 repeating units and hence also to include HALS that are sometimes designated as being “polymeric” HALS.

The hindered amine-type ultraviolet light stabilizer (III) is preferably chosen from those comprising at least one molecular fragment according to Formula IV

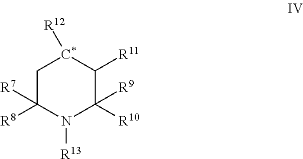

wherein

each of R⁷, R⁸, R⁹ and R¹⁰ is, independently, chosen from C₁-C₂₀ hydrocarbyl, with the proviso that R⁷ and R⁸ and/or R⁹ and R¹⁰ taken together with the carbon to which they are attached may form a C₅₋₁₀ cycloalkyl;

R¹¹ is chosen from: H and C₁-C₈ hydrocarbyl;

R¹² is chosen from: H and C₁-C₈ hydrocarbyl;

R¹³ represents H, —OH, —CH₂CN, C₁₋₂₀ hydrocarbyl, —C(═O)—R or —OR where R is a C₁₋₂₀ hydrocarbyl, said hydrocarbyl being optionally substituted with one or more hydroxyl, C₁₋₃₀ alkoxy or C₂₋₃₀ alkanoyl; and
the molecular fragment is bonded to the rest of the compound via the carbon atom marked * with the proviso that the molecular fragment can form a spiro structure with the rest of the compound so that R¹² does not exist;

and/or to Formula V

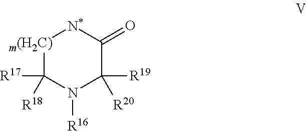

wherein

m is an integer from 1 to 2;

each of R¹⁷, R¹⁸, R¹⁹ and R²⁰ is, independently, chosen from C₁-C₂₀ hydrocarbyl, with the proviso that R¹⁷ and R¹⁸ and/or R¹⁹ and R²⁰ taken together with the carbon to which they are attached may form a C₅₋₁₀ cycloalkyl;

R¹⁶ represents H, —OH, —CH₂CN, C₁₋₂₀ hydrocarbyl, —C(═O)—R or —OR where R is a C₁₋₂₀hydrocarbyl, said hydrocarbyl being optionally substituted with one or more hydroxyl, C₁₋₃₀alkoxy or C₂₋₃₀alkanoyl; and

the molecular fragment is bonded to the rest of the compound via the nitrogen atom marked *.

Suitable hindered amine light stabilizers (III) include poly[(6-[(1,1,3,3-tetramethylbuty)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]); 1,6-hexanediamine, N,N′-bis(2,2,6,6-tetramethyl-4-piperidinyl)-, polymers with 2,4-dichloro-6-(4-morpholinyl)-1,3,5-triazine; 1,6-hexanediamine, N,N′-bis(2,2,6,6-tetramethyl-4-piperidinyl)-, polymers with morpholine-2,4,6-trichloro-1,3,5-triazine reaction products, methylated; 1,6-hexanediamine, N,N′-bis(2,2,6,6-tetramethyl-4-piperidinyl)-, polymer with 2,4,6-trichloro-1,3,5-triazine, reaction products with 3-bromo-1-propene, N-butyl-1-butanamine and N-butyl-2,2,6,6-tetramethyl-4-piperidinamine, oxidized, hydrogenated; N,N′,N″,N′″-tetrakis(4,6-bis(butyl-(N-methyl-2,2,6,6-tetramethylpiperidin-4-yl)amino)triazin-2-yl)-4,7-diazadecane-1,10-diamine; butanedioc acid, dimethylester, polymer with 4-hydroxy-2,2,6,6-tetramethyl-1-piperidine ethanol; 1,6-hexanediamine, N,N′-bis(2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine; polymer of 2,2,4,4-tetramethyl-7-oxa-3.20-diaza-20 (2,3-epoxi-propyl)-dispiro[5.1.11.2]-heneicosane-21-on; a copolymer of mixed C20 to C24 alpha-olefins and (2,2,6,6-tetramethylpiperidin-4-yl)succinimide; 1,2,3,4-butanetetracarboxylicacid, mixed 1,2,2,6,6-pentamethyl-4-piperidinyl and tridecyltetraesters; 1,2,3,4-butanetetracarboxylic acid, 1,2,2,6,6-pentamethyl-4-piperdinyl tridecyl ester; 1,2,3,4-butanetetracarboxylic acid, polymer with 2,2-bis(hydroxymethyl)-1,3-propanediol and 3-hydroxy-2,2-dimethylpropanal, 1,2,2,6,6-pentamethyl-4-piperidinyl ester; 1,2,3,4-butanetetracarboxylic acid polymer with 2,2-bis(hydroxymethyl)-1,3-propane-diol and 3-hydroxy-2,2-dimethylpropanal, 2,2,6,6-tetramethyl-4-piperidinyl ester 1,2,3,4-butanetetracarboxylic acid polymer with 2,2-bis(hydroxymethyl)-1,3-propane-diol and 3-hydroxy-2,2-dimethylpropanal, 2,2,6,6-tetramethyl-4-piperidinyl ester; 1,3-propanediamine, N,N″-1,2-ethanediylbis-, polymer with 2,4,6-trichloro-1,3,5-triazine, reaction products with N-butyl-2,2,6,6-tetramethyl-4-piperidinamine; 2,2,6,6-tetramethyl-4-piperidinyl ester of C12-C22 saturated and C18-unsaturated fatty acid reacted with oxidized polyethylene; 2-piperazinone,1,1′,1″-[1,3,5-triazine-2,4,6-triyltris[(cyclohexylimino)-2,1-ethanediyl]]tris[3,3,4,5,5-pentamethyl-; 2-piperazinone,1,1′,1″-[1,3,5-triazine-2,4,6-triyltris[(cyclohexylimino)-2,1-ethanediyl]]tris[3,3,5,5-tetramethyl-; poly[4-hydroxy-1-(2-hydroxyethoxy)-2,2,6,6-tetramethylpiperidin-4-yl succinate]; 2-[(2-hydroxyethyl)amino]-4,6-bis[N-(1-cyclohexyloxy-2,2,6,6-tetramethylpiperidin-4-yl)butylamino-1,3,5-triazine; the condensate of N,N′-bis(2,2,6,6-tetramethylpiperidin-4-yl)hexamethylenediamine and 4-cyclohexylamino-2,6-dichloro-1,3,5-triazine; the copolymer of methylmethacrylate with ethyl acrylate and 2,2,6,6-tetramethylpiperidin-4-yl acrylate; polymethyl[propyl-3-oxy(2′,2′,6′,6′-tetramethyl-4,4′-piperidinyl)]siloxane; polymethyl[propyl-3-oxy(1′,2′,2′,6′,6′-pentamethyl-4,4′-piperidinyl)]siloxane; the condensate of 1,2-bis(3-aminopropylamino)ethane-2,4,6-trichloro-1,3,5-triazine and 4-butylamino-2,2,6,6-tetramethylpiperidine; the copolymer of ethylene and the esterification product of 2,2,6,6-tetramethyl-4-piperidinol and acrylic acid; the copolymer of ethylene and the esterification product of 1,2,2,6,6-pentamethyl-4-piperidinol and acrylic acid; the condensate of 2-chloro-4,6-bis(4-n-butylamino-1,2,2,6,6-pentamethylpiperidyl)-1,3,5-triazine and 1,2-bis-(3-aminopropylamino)ethane; 1,3,5-triazine-2,4,6-triamine, N,N′″-1,2-ethanediylbis(N-(3-((4,6-bis(butyl(2,2,6,6-tetramethyl-4-piperidinyl)amino)-1,3,5-triazin-2-yl)amino)propyl)-N,N″-bis)(2,2,6,6-tetramethyl-4-piperidinyl)-; N,N bis(2,2,6,6-tetramethyl-4-piperidyl)hexamethylenediamine-1,2-dibromoethane,copolymer; and mixtures thereof.

Preferred hindered amine-type UV-stabilizers (III) are selected from 1,6-hexanediamine, N,N′-bis(2,2,6,6-tetramethyl-4-piperidinyl)-, polymers with morpholine-2,4,6-trichloro-1,3,5-triazine reaction products, methylated; 1,6-hexanediamine, N,N′-bis(2,2,6,6-tetramethyl-4-piperidinyl)-, polymers with 2,4-dichloro-6-(4-morpholinyl)-1,3,5-triazine; poly[(6-[(1,1,3,3-tetramethylbuty)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]]); butanedioc acid, dimethylester, polymer with 4-hydroxy-2,2,6,6-tetramethyl-1-piperidine ethanol; 1,6-hexanediamine, N,N′-bis(2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine; 2-[(2-hydroxyethyl)amino]-4,6-bis[N-(1-cyclohexyloxy-2,2,6,6-tetramethylpiperidin-4-yl)butylamino-1,3,5-triazine; 1,6-hexanediamine, N,N′-bis(2,2,6,6-tetramethyl-4-piperidinyl)-, polymer with 2,4,6-trichloro-1,3,5-triazine, reaction products with 3-bromo-1-propene, N-butyl-1-butanamine and N-butyl-2,2,6,6-tetramethyl-4-piperidinamine, oxidized, hydrogenated; 1,3,5-triazine-2,4,6-triamine,N,N′″-[1,2-ethane-diyl-bis[[[4,6-bis-[butyl-(1,2,2,6,6-pentamethyl-4-piperidinyl)amino]-1,3,5-triazine-2-yl]imino]-3,1-propanediyl]]bis-[N′,N″-dibutyl-N′,N″-bis(1,2,2,6,6-pentamethyl-4-piperidinyl)-; 1,3,5-triazine-2,4,6-triamine, N,N″′-1,2-ethanediylbis(N-(3-((4,6-bis(butyl(2,2,6,6-tetramethyl-4-piperidinyl)amino)-1,3,5-triazin-2-yl)amino)propyl)-N,N″-bis)(2,2,6,6-tetramethyl-4-piperidinyl)-; a condensate of N,N′-bis(2,2,6,6-tetramethylpiperidin-4-yl)hexamethylenediamine and 4-cyclohexylamino-2,6-dichloro-1,3,5-triazine; N,N bis(2,2,6,6-tetramethyl-4-piperidyl)hexamethylenediamine-1,2-dibromoethane,copolymer; polymer of 2,2,4,4-tetramethyl-7-oxa-3.20-diaza-20 (2,3-epoxi-propyl)-dispiro[5.1.11.2]-heneicosane-21-on; 1,3-propanediamine, N,N″-1,2-ethanediylbis-, polymer with 2,4,6-trichloro-1,3,5-triazine, reaction products with N-butyl-2,2,6,6-tetramethyl-4-piperidinamine; a copolymer of mixed C20 to C24 alpha-olefins and (2,2,6,6-tetramethylpiperidin-4-yl)succinimide; 1,2,3,4-butanetetracarboxylic acid, polymer with 2,2-bis(hydroxymethyl)-1,3-propanediol and 3-hydroxy-2,2-dimethylpropanal, 1,2,2,6,6-pentamethyl-4-piperidinyl ester; 1,2,3,4-butanetetracarboxylic acid polymer with 2,2-bis(hydroxymethyl)-1,3-propane-diol and 3-hydroxy-2,2-dimethylpropanal, 2,2,6,6-tetramethyl-4-piperidinyl ester; copolymer of methylmethacrylate with ethyl acrylate and 2,2,6,6-tetramethylpiperidin-4-yl acrylate; polymethyl[propyl-3-oxy(2′,2′,6′,6′-tetramethyl-4,4′-piperidinyl)]siloxane; polymethyl[propyl-3-oxy(1′,2′,2′,6′,6′-pentamethyl-4,4′-piperidinyl)]siloxane; the condensate of 2-chloro-4,6-bis(4-n-butylamino-1,2,2,6,6-pentamethylpiperidyl)-1,3,5-triazine and 1,2-bis-(3-aminopropylamino)ethane; the condensate of 1,2-bis(3-aminopropylamino)ethane-2,4,6-trichloro-1,3,5-triazine and 4-butylamino-2,2,6,6-tetramethylpiperidine; a copolymer of ethylene and the esterification product of 2,2,6,6-tetramethyl-4-piperidinol and acrylic acid; a copolymer of ethylene and the esterification product of 1,2,2,6,6-pentamethyl-4-piperidinol and acrylic acid; poly[4-hydroxy-1-(2-hydroxyethoxy)-2,2,6,6-tetramethylpiperidin-4-yl succinate]; and mixtures thereof.

UV-stabilizers (III) are more preferably selected from 1,6-hexanediamine, N,N′-bis(2,2,6,6-tetramethyl-4-piperidinyl)-, polymers with 2,4-dichloro-6-(4-morpholinyl)-1,3,5-triazine; 1,6-hexanediamine, N,N′-bis(2,2,6,6-tetramethyl-4-piperidinyl)-, polymers with morpholine-2,4,6-trichloro-1,3,5-triazine reaction products, methylated; 1,6-hexanediamine, N,N′-bis(2,2,6,6-tetramethyl-4-piperidinyl)-, polymer with 2,4,6-trichloro-1,3,5-triazine, reaction products with 3-bromo-1-propene, N-butyl-1-butanamine and N-butyl-2,2,6,6-tetramethyl-4-piperidinamine, oxidized, hydrogenated; 1,3,5-triazine-2,4,6-triamine,N,N′″-[1,2-ethane-diyl-bis[[[4,6-bis-[butyl-(1,2,2,6,6-pentamethyl-4-piperidinyl)amino]-1,3,5-triazine-2-yl]imino]-3,1-propanediyl]]bis-[N′,N″-dibutyl-N′,N″-bis(1,2,2,6,6-pentamethyl-4-piperidinyl)-; butanedioc acid, dimethylester, polymer with 4-hydroxy-2,2,6,6-tetramethyl-1-piperidine ethanol; 1,6-hexanediamine, N,N′-bis(2,2,6,6-tetramethyl-4-piperidinyl)-, polymer with 2,4,6-trichloro-1,3,5-triazine, reaction products with, N-butyl-1-butanamine and N-butyl-2,2,6,6-tetramethyl-4-piperidinamine; 1,2,3,4-butanetetracarboxylicacid, mixed 1,2,2,6,6-pentamethyl-4-piperidinyl and tridecyltetraesters; 1,2,3,4-butanetetracarboxylic acid, polymer with 2,2-bis(hydroxymethyl)-1,3-propanediol and 3-hydroxy-2,2-dimethylpropanal, 1,2,2,6,6-pentamethyl-4-piperidinyl ester; 2,2,6,6-tetramethyl-4-piperidinyl ester of C12-21,C18-unsaturated fatty acid reacted with oxidized polyethylene; poly[4-hydroxy-1-(2-hydroxyethoxy)-2,2,6,6-tetramethylpiperidin-4-yl succinate]; and mixtures thereof.

The light stabilizer (III) chosen from hindered amine light stabilizers (HALS) different from compound (II) is preferably chosen from monomeric and oligomeric HALS having a number average molecular weight (Mn) of at least 900, more preferably from oligomeric HALS having a Mn of higher than 1500 but not more than 4500, more preferably not more than 3000.

Most preferred light stabilizer (III) is 1,6-hexanediamine, N,N-bis(2,2,6,6-tetramethyl-4-piperidinyl)-, polymers with morpholine-2,4,6-trichloro-1,3,5-triazine reaction products, methylated, which is commercially available as CYASORB®UV-3529 light stabilizer from Cytec Industries Inc.; or a mixture of 1,6-hexanediamine, N,N′-bis(2,2,6,6-tetramethyl-4-piperidinyl)-, polymers with 2,4-dichloro-6-(4-morpholinyl)-1,3,5-triazine and 1,6-hexanediamine, N,N′-bis(2,2,6,6-tetramethyl-4-piperidinyl)-, polymers with morpholine-2,4,6-trichloro-1,3,5-triazine reaction products, methylated.

The amount of ultraviolet light stabilizer (III) present in the polyolefin film is generally from 0.05 to 2.0% by weight. Preferably the amount of ultraviolet light stabilizer (III) is at least 0.4% by weight, more preferably at least 0.6% by weight. The amount of ultraviolet light stabilizer (III) preferably does not exceed 1.9% by weight.

The stabilizing amount of the stabilizer composition in the polyolefin films may vary over a broad range as determined by routine experimentation. Typically, the total amount (in weight) of ultraviolet absorber according to formula (I), ultraviolet stabilizer (II) and ultraviolet stabilizer (III) in the polyolefin film is generally at least 0.1% by weight, preferably at least 0.6% by weight. The total amount usually does not exceed 2.9% by weight, preferably it does not exceed 2.5% by weight.

The amount of ultraviolet light stabilizer (I) present in the polyolefin is preferably from 0.01 to 0.6% by weight, the amount of ultraviolet light stabilizer (II) present in the polyolefin is preferably from 0.02 to 0.9% by weight and the amount of light stabilizer (III) present in the polyolefin is preferably from 0.05 to 2.0% by weight.

In certain embodiments, the weight ratio of ultraviolet light stabilizer (III) to ultraviolet light stabilizer (I) can range from 3:1 to 20:1.

The polyolefin films according to the present invention can further contain various conventional additives, such as antioxidants, especially hindered phenolic antioxidants; phosphites; phosphonites; acid scavengers; UV screeners or absorbers, such as benzotriazoles, benzophenones and benzylidene malonates; processing aids; antiblocking agents; antidripping agents; antifogging agents; antimist agents; antidust agents; antifungal agents; photoselective agents; pigments; thermic agents; photo-catalysts; biodegradable fillers; metal carbonates such as calcium carbonates; etc. and mixtures thereof. The amount of such further additives usually does not exceed 20% by weight. When used as transparent films, the total amount of further additives preferably does not exceed 15% by weight of the formulated film.

The polyolefin films according to the invention preferably contains at least one further stabilizer selected from the group consisting of hindered benzoates, phenolic antioxidants, phosphites and phosphonites and mixtures thereof, more preferably in a total amount of from 0.001 to 1.5% by weight.

The polyolefin films according to the invention more preferably contains at least one further stabilizer selected from the group consisting of hindered benzoates (VI), more specifically from hindered benzoates of formula VI

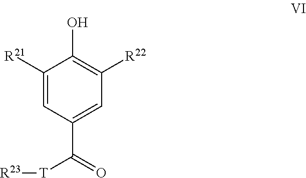

wherein

each of R²¹ and R²² is, independently, chosen from C₁₋₁₂ alkyl,

T represents O or NR²⁴, where R²⁴ is H or C₁₋₃₀ hydrocarbyl,

R²³ is H or C₁₋₃₀ hydrocarbyl.

In the hindered benzoates of formula VI, each of R²¹ and R²² are preferably, independently, chosen from branched alkyls, more preferably from branched C₃₋₆ alkyls.

In the hindered benzoates of formula VI, T is preferably O.

In the hindered benzoates of formula VI, R²³ is preferably a C₁₋₃₀ alkyl, C₁₋₃₀ alkenyl or a phenyl substituted with one or more C₁₋₆ alkyl groups.

Suitable hindered benzoates include 2,4-di-tert-butylphenyl-3,5-di-tert-butyl-4-hydroxybenzoate; hexadecyl-3,5-di-tert-butyl-4-hydroxybenzoate; octadecyl-3,5-di-tert-butyl-4-hydroxybenzoate; octyl-3,5-di-tert-butyl-4-hydroxybenzoate; decyl-3,5-di-tert-butyl-4-hydroxybenzoate; dodecyl-3,5-di-tert-butyl-4-hydroxybenzoate; tetradecyl-3,5-di-tert-butyl-4-hydroxybenzoate; behenylyl-3,5-di-tert-butyl-4-hydroxybenzoate; 2-methyl-4,6-di-tert-butylphenyl-3,5-di-tert-butyl-4-hydroxybenzoate; butyl-3-[3-t-butyl-4-(3,5-di-t-butyl-4-hydroxybenzoyloxy)phenyl]propionate; and mixtures thereof.

Preferred hindered benzoates are 2,4-di-tert-butylphenyl-3,5-di-tert-butyl-4-hydroxybenzoate and hexadecyl-3,5-di-tert-butyl-4-hydroxybenzoate, as well as mixtures thereof.

The amount of hindered benzoate (VI) present in the polyolefin film is preferably from 0.01 to 1% by weight. More preferably the amount of hindered benzoate (VI) is at least 0.1% by weight. The amount of hindered benzoate (VI) more preferably does not exceed 0.6% by weight.

The polyolefin films according to the invention can be obtained by any process suitable for preparing polyolefin films, such as blown film or cast film extrusion.

The films are usually prepared by blending the UV absorber (I), the UV stabilizer (II), the UV stabilizer (III) and optionally further additives with the polyolefin. The stabilizers and optional further additives can be added to the polyolefin in the form of a powder, granules or a masterbatch which contains these components in a concentration that is higher than the final concentration in the film. The components can be blended with the polyolefin separately or two or more components can be mixed with each other before being added to the polyolefin. The components are preferably blended with the polyolefin in a single or twin screw extruder, continuous mixer or other equipment used for compounding additives into polymers. The stabilized polyolefin is then further processed into a film with the desired thickness.

The polyolefin films according to the present invention present a significantly better stability against long term exposure to light, even in the presence of agrochemicals such as sulfur based pesticides, insecticides, fumigants or soil disinfectants, while maintaining other properties required for agricultural films such as optical properties, absence of visible defects, mechanical properties such as tensile properties, impact resistance and elongation, etc. Therefore, the polyolefin films according to the present invention are of particular interest for agricultural applications such as greenhouse films, agricultural films, greenhouse covers, greenhouse double roof films, tunnel films, high tunnel films, low-tunnel films, small tunnel films, polytunnel films, mulch and solarization films. The present invention therefore also relates to the use of polyolefin films as described here above for agricultural applications, especially for those wherein agrochemicals such as pesticides, insecticides, fumigants, and soil disinfectants are used.

### EXAMPLES

The following examples are provided to assist one skilled in the art to further understand certain embodiments of the present invention. These examples are intended for illustration purposes and are not to be construed as limiting the scope of the present invention.

### Example 1

The polyethylene (LDPE) film formulations including the UV stabilizer compositions as described in Table 1 and 0.09% by weight of a hindered phenol/phosphite antioxidant blend (commercialized as CYANOX®2777 antioxidant) are dry blended with low density polyethylene Westlake LDPE 1810E. The formulations are compounded twice to ensure a proper dispersion. Firstly, the LDPE film formulations are compounded using a Killion single screw extruder set with a 60 mesh screen, at 181° C., and a screw speed of 100 RPM. Secondly, the compounded LDPE film formulations are extruded to 200 microns LDPE films using the Killion extruder with the film die, and 60 mesh screen running with a melt temperature of 177° C. and a screw speed of 25 RPM.

In order to test the UV performance of the UV stabilizer compositions in the LDPE films, the films are exposed to UV light after periodic treatment with an agrochemical solution. To simulate exposure to agrochemicals in the field, the film samples are treated with a Metham Sodium solution prior to any UV exposure and then are treated again after every 336 hours (every 2nd week) of UV exposure. The film samples are dipped in a 0.5 percent (wt./wt.) solution of Metham Sodium (sodium salt of methyldithiocarbamate) for 2 hours, dried overnight, and then placed in the Q UV-A (Q-Panel fluorescent UV exposure unit). The exposure to the Metham Sodium solution is repeated each 2nd week (336 hours intervals). The residual sulfur content of the formulated LDPE film samples is analyzed by Parr Bomb Prep/IC analysis after each treatment to ensure that the sulfur residues remain on the films.

The film samples are mounted on holders and exposed in a Q-Panel fluorescent UV exposure unit according to the following conditions from ASTM G154: UVA-340 nm lamp, irradiance of 0.77 W/m²/nm at 340 nm, with an exposure cycle of 8 hours of UV at 70° C. black panel temperature followed by 4 hours of condensation at 50° C. black panel temperature.

In order to determine the mechanical properties (e.g. % elongation at break) of the treated and UV exposed LDPE films, samples are cut into dog-bone shaped specimens of type 5B (ISO 527-2) using a punch press after each 336 h interval (Na-Metham treatment followed by UV light exposure). Samples are cut so that the gauge portion of the tensile bar ran perpendicular to the machine direction of the film (i.e., the tensile bars are cut across the machine direction). Five specimens are cut of each sample. Samples are tested on an MTS tensile tester at 50 mm/min crosshead speed. The median value of the five samples is used for all analyses. To compare the final UV performances of the LDPE film samples, the time (in hours) to 50 percent of retained % elongation (T50) for each of the four formulated 200 microns LDPE film samples is determined. The results obtained are presented in Table 1. Films are classified as failed if they exhibit an elongation value that is 50% or less of the original elongation of the film prior to exposure.

TABLE 1

| | Formulation | T50 (hours) |
|---|---|---|
| 1.1R | 0.2 wt.-% of triazine(1) + 1 wt.-% of oligomeric | 2350 |
| | HALS(2) | |
| 1.2 | 0.17 wt.-% of triazine(1) + 0.83 wt.-% of | 2825 |
| | oligomeric HALS(2) + 0.3 wt.-% of UV-3853(3) | |
| 1.3 | 0.17 wt.-% of triazine(1) + 0.83 wt.-% of | 3275 |
| | oligomeric HALS(2) + 0.7 wt.-% of UV-3853(3) | |

(1)4,6-bis-(2,4-dimethylphenyl)-2-(2-hydroxy-4-octyloxyphenyl)-s-triazine (CYASORB ®UV-1164 light absorber available from Cytec Industries Inc.)
(2)1,6-hexanediamine, N,N′-bis(2,2,6,6-tetramethyl-4-piperidinyl)-, polymers with morpholine-2,4,6-trichloro-1,3,5-triazine reaction products, methylated (CYASORB ®UV-3529 light stabilizer available from Cytec Industries Inc.)
(3)UV-3853 = UV stabilizer commercialized as CYASORB ®UV-3853 light stabilizer by Cytec Industries Inc., which predominantly contains a mixture of C16-18 fatty acid esters of 2,2,6,6-tetramethylpiperidinol.

As can be seen from the data in Table 1, the LDPE films according to the invention are far superior to those of the prior art, providing protection from UV light in a Na-Metham environment.

### Example 2

LDPE films comprising the UV stabilizer compositions as described in Table 2 and 0.09 wt. % of hindered phenol/phosphite antioxidant blend (commercialized as CYANOX®2777 antioxidant) are prepared as described in Example 1.

In order to test the UV performance of the UV stabilizer compositions in the LDPE films, the films are exposed to UV light after periodic treatment with sulfur vapor generated through sublimation of elemental sulfur. The LDPE film samples are exposed to the vapors of sulfur from sublimed sulfur prior to any UV exposure and then are treated again after every 336 hours (2nd week) of UV exposure. The LDPE film samples are exposed to the vapors of sulfur from sublimed sulfur for ½ an hour in a specially designed closed cabinet and then placed in the Q UV-A (Q-Panel fluorescent UV exposure unit). The residual sulfur content of the formulated LDPE film samples is analyzed by Parr Bomb Prep/IC analysis after each treatment to ensure that the sulfur residues remain on the films.

The film samples are mounted on holders and exposed in a Q-Panel fluorescent UV exposure unit according to the following conditions from ASTM G154: UVA-340 nm lamp, irradiance of 0.77 W/m²/nm at 340 nm, with an exposure cycle of 8 hours of UV at 60° C. black panel temperature followed by 4 hours of condensation at 50° C. black panel temperature.

In order to determine the mechanical properties (e.g. % elongation at break) of the treated and UV exposed LDPE films, samples are cut into dog-bone shaped specimens of type 5B (ISO 527-2) using a punch press after each 336 h interval (sulfur vapor treatment followed by UV light exposure). Samples are cut so that the gauge portion of the tensile bar runs perpendicular to the machine direction of the film (i.e. the tensile bars are cut across the machine direction). Five specimens are cut of each sample. Samples are tested on an MTS tensile tester at 50 mm/min crosshead speed. The median value of the five samples is used for all analyses. To compare the final UV performances of the LDPE film samples, the times (in hours) to 50 percent of retained % elongation (T50) for each 200 microns LDPE film samples is determined. Films are classified as failed if they exhibit an elongation value that is 50% or less of the original elongation of the film prior to exposure. The results are presented in Table 2.

TABLE 2

| | | T50 |
|---|---|---|
| | Formulation | (hours) |
| 2.1R | 0.28 wt.-% of triazine(1) + 1.42 wt.-% of oligomeric | 2950 |
| | HALS(2) | |
| 2.2 | 0.2 wt.-% of triazine(1) + 1 wt.-% of oligomeric | 3800 |
| | HALS(2) + 0.5 wt.-% of UV-3853(3) | |
| 2.3R | 0.2 wt.-% of triazine(1) + 1 wt.-% of oligomeric | 3150 |
| | HALS(2) + 0.5 wt.-% of TINUVIN ®770 | |
| 2.4R | 0.2 wt.-% of triazine(1) + 1 wt.-% of oligomeric | 2400 |
| | HALS(2) + 0.5 wt.-% of TINUVIN ®765 | |
| 2.5R | 0.2 wt.-% of triazine(1) + 1 wt.-% of oligomeric | 2050 |
| | HALS(2) + 0.5 wt.-% of TINUVIN ®123 | |
| 2.6R | 0.2 wt.-% of triazine(1) + 1.5 wt.-% of oligomeric | 3650 |
| | HALS(2) | |
| 2.7R | 0.2 wt.-% of triazine(1) + 1 wt.-% of oligomeric | 2350 |
| | HALS(2) + 0.5 wt.-% of CYASORB ®UV-3346 | |
| | light stabilizer | |
| 2.8R | 0.2 wt.-% of triazine(1) + 1 wt.-% of oligomeric | 2450 |
| | HALS(2) + 0.5 wt.-% of DAMA-10 | |

(1)4,6-bis-(2,4-dimethylphenyl)-2-(2-hydroxy-4-octyloxyphenyl)-s-triazine (CYASORB ®UV-1164 light absorber available from Cytec Industries Inc.)
(2)1,6-hexanediamine, N,N′-bis(2,2,6,6-tetramethyl-4-piperidinyl)-, polymers with morpholine-2,4,6-trichloro-1,3,5-triazine reaction products, methylated (CYASORB ®UV-3529 light stabilizer available from Cytec Industries Inc.)
(3)UV-3853 = UV stabilizer commercialized as CYASORB ®UV-3853 light stabilizer by Cytec Industries Inc., which predominantly contains a mixture of C16-18 fatty acid esters of 2,2,6,6-tetramethylpiperidinol.
TINUVIN ®770 = bis(2,2,6,6-tetramethylpiperidin-4-yl) sebacate
TINUVIN ®765 = bis(1,2,2,6,6-pentamethylpiperidin-4-yl) sebacate
TINUVIN ®123 = bis(1-octyloxy-2,2,6,6-tetramethylpiperidin-4-yl) sebacate
CYASORB ®UV-3346 light stabilizer = 1,6-hexanediamine, N,N′-bis(2,2,6,6-tetramethyl-4-piperidinyl)-, polymers with 2,4-dichloro-6-(4-morpholinyl)-1,3,5-triazine
DAMA-10 = didecylmethylamine

As can be clearly seen from the data in Table 2, the LDPE film according to the invention is far superior at providing protection from UV light after exposure to vapors of sulfur compared to films of the prior art, which contain no tetramethyl-4-piperidine compound of formula (II), or wherein the tetramethyl-4-piperidine compound of formula (II) is replaced by other known HALS or by a tertiary amine.

As employed above and throughout the disclosure, various terms are provided to assist the reader. Unless otherwise defined, all terms of art, notations and other scientific terminology used herein are intended to have the meanings commonly understood by those of skill in the chemical arts. As used herein and in the appended claims, the singular forms include plural referents unless the context clearly dictates otherwise. All numbers expressing quantities of ingredients, reaction conditions, and so forth used in the specification and claims are to be understood as being modified in all instances by the term “about.” Similarly, all numbers expressed in a range as indicated by the word “between” include the upper and lower limits in the range. Accordingly, unless indicated to the contrary, the numerical parameters set forth in the specification and attached claims are approximations that may vary depending upon the desired properties sought to be obtained by the present invention.

Various patent and/or scientific literature references have been referred to throughout this application. The disclosures of these publications as they relate to the subject matter of the present invention are hereby incorporated by reference as if written herein. In the case of conflicting terms, the terms of this document will take preference. In view of the above description, as well as the accompanying figures and examples, one of ordinary skill in the art will be able to practice the invention as claimed without undue experimentation.

Although the foregoing description has shown, described, and pointed out the fundamental novel features of the present invention, it will be understood that various omissions, substitutions, and changes in the form of compositions, as well as the uses thereof, may be made by those skilled in the art, without departing from the scope of the present teachings. Consequently, the scope of the present invention should not be limited to the foregoing discussion, but should be defined by the appended claims.

What is claimed is:

1. A method for stabilizing polyolefin thin films against degradation due to thermal oxidation, light, or the use of agrochemicals, the method comprising:
incorporating into the polyolefin thin film a stabilizing amount of a stabilizer composition comprising:
i) at least one o-hydroxyphenyl triazine ultraviolet light absorber (I) selected from 2-(2′-hydroxyphenyl)-1,3,5-triazine compounds according to Formula I: 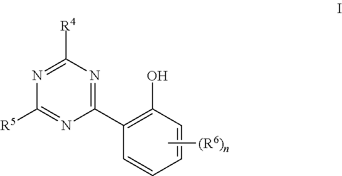
wherein
each of R⁴ and R⁵ is independently chosen from C₆₋₁₀ aryl; or C₆₋₁₀ aryl substituted by one to three of: hydroxyl, halogen, C₁₋₁₂ hydrocarbyl, C₁₋₁₂ alkoxy, C₁₋₁₂ alkoxyester, C₂₋₁₂ alkanoyl, phenyl or by phenyl substituted by one to three of: hydroxyl, halogen, C₁₋₁₂ hydrocarbyl, C₁₋₁₂ alkoxy, C₁₋₁₂ alkoxyester, and C₂₋₁₂ alkanoyl, or by mixtures thereof; or mono- or di-C₁₋₁₂ hydrocarbyl-substituted amino; or C₂₋₁₂ alkanoyl; or C₁₋₁₂ alkyl; or C₁₋₁₂ alkoxy;
n is from 0 to 4; and
R⁶ is a substituent that is the same or different, at from 0 to 4 positions of the 2-hydroxyphenyl portion of Formula I, and is independently chosen from hydroxyl, halogen, C₁₋₁₂ hydrocarbyl, C₁₋₁₂ alkoxy, C₁₋₁₂ alkoxyester, C₂₋₁₂ alkanoyl and phenyl;
ii) at least one hindered amine ultraviolet light stabilizer selected from tetramethyl-4-piperidinyl compounds (II) according to Formula II 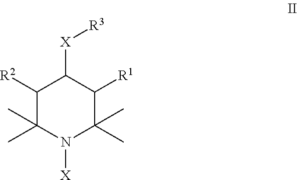
wherein:
X represents a bridging group selected from the group of —O—C(═O)—, —CR′₂—C(═O)—, —CR′₂—C(═O)—NR′—, —NR′—C(═O)—, —C(═O)—NR′—, —O—, —NR′— or —C(═O)— where each R′, independently, represents H or C₁₋₂₀ hydrocarbyl,
Z represents H, —R, —C(═O)—R or —OR where R is a C₁₋₂₀ hydrocarbyl, said hydrocarbyl being optionally substituted with one or more hydroxyl, C₁₋₃₀ alkoxy or C₂₋₃₀ alkanoyl,
R³ is a C₆₋₃₀ hydrocarbyl, and
each of R¹ and R² is, independently, chosen from H and C₁-C₆ alkyl; and
iii) at least one ultraviolet light stabilizer (III) chosen from a hindered amine light stabilizer (HALS) different from the compound of formula II.

2. The method according to claim 1, wherein the 2-(2′-hydroxyphenyl)-1,3,5-triazine compound (I) is 4,6-bis-(2,4-dimethylphenyl)-2-(2-hydroxy-4-octyloxyphenyl)-s-triazine.

3. The method according to claim 1, wherein the tetramethyl-4-piperidinyl compound (II) is selected from compounds of formula IIa 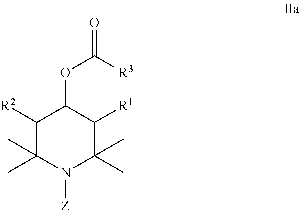
wherein
Z is H, a C₁₋₆ alkyl or -OR where R is a C₁₋₁₀ alkyl optionally substituted with hydroxyl, C₁₋₂₂ alkoxy or C₂₋₂₂ alkanoyl;
R³ is a C₆₋₃₀ alkyl or C₆₋₃₀ alkenyl; and
each of R¹ and R² is, independently, chosen from H and C₁-C₆ alkyl.

4. The method according to claim 1, wherein the tetramethyl-4-piperidinyl compound (II) is selected from those of formula II, IIa, IIb and/or IIc 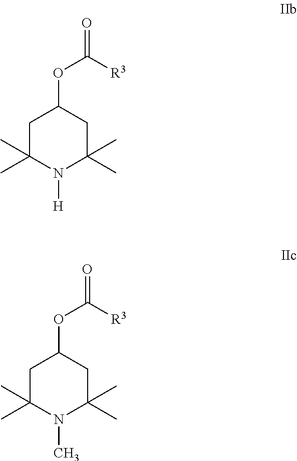
wherein R³ is a C₁₂₋₂₂ alkyl or C₁₂₋₂₂ alkenyl.

5. The method according to claim 1, wherein the tetramethyl-4-piperidinyl compound (II) is selected from 2,2,6,6-tetramethylpiperidin-4-yl-octadecanoate; 2,2,6,6-tetramethylpiperidin-4-yl-hexadecanoate; and mixtures thereof; 1,2,2,6,6-pentamethylpiperidin-4-yl-octadecanoate; 1,2,2,6,6-pentamethylpiperidin-4-yl-hexadecanoate; and mixtures thereof.

6. The method according to claim 1, wherein the hindered amine light stabilizer compound (III) is selected from those comprising at least one molecular fragment according to Formula IV 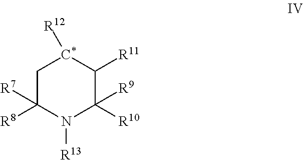
wherein
each of R⁷, R⁸, R9 and R¹⁰ is, independently, chosen from C₁-C₂₀ hydrocarbyl, with the proviso that R⁷ and R⁸ and/or R⁹ and R¹⁰ taken together with the carbon to which they are attached may form a C₅₋₁₀ cycloalkyl;
R¹¹ is chosen from: H and C₁-C₈ hydrocarbyl;
R¹² is chosen from H and C₁-C₈ hydrocarbyl;
R¹³ represents H, —OH, —CH₂CN, C₁₋₂₀ hydrocarbyl, —C(═O)—R or —OR where R is a C₁₋₂₀ hydrocarbyl, said hydrocarbyl being optionally substituted with one or more hydroxyl, C₁₋₃₀ alkoxy or C₂₋₃₀ alkanoyl; and
the molecular fragment is bonded to the rest of the compound via the carbon atom marked * with the proviso that the molecular fragment can form a spiro structure with the rest of the compound so that R¹² does not exist;
and/or to Formula V 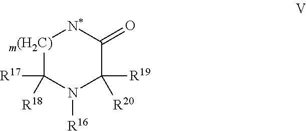
wherein
m is an integer from 1 to 2;
each of R¹⁷, R¹⁸, R¹⁹ and R²⁰ is, independently, chosen from C₁-C₂₀ hydrocarbyl, with the proviso that R¹⁷ and R¹⁸ and/or R¹⁹ and R²⁰ taken together with the carbon to which they are attached may form a C₅₋₁₀ cycloalkyl;
R¹⁶ represents H, —OH, —CH₂CN, C₁₋₂₀ hydrocarbyl, —C(═O)—R or —OR where R is a C₁₋₂₀ hydrocarbyl, said hydrocarbyl being optionally substituted with one or more hydroxyl, C₁₋₃₀ alkoxy or C₂₋₃₀ alkanoyl; and
the molecular fragment is bonded to the rest of the compound via the nitrogen atom marked *.

7. The method according to claim 1, wherein the hindered amine light stabilizer (III) is1,6-hexanediamine, N,N′-bis (2,2,6,6-tetramethyl-4-piperidinyl)-, polymers with morpholine-2,4,6-trichloro-1,3,5-triazine reaction products, methylated or a mixture of 1,6-hexanediamine, N,N′-bis(2,2,6,6-tetramethyl-4-piperidinyl)-, polymers with 2,4-dichloro-6-(4-morpholinyl)-1,3,5-triazine and 1,6-hexanediamine, N,N′-bis(2,2,6,6-tetramethyl-4-piperidinyl)-, polymers with morpholine-2,4,6-trichloro-1,3,5-triazine reaction products, methylated.

8. The method according to claim 1, wherein the amount of ultraviolet light stabilizer (I) present in the polyolefin is from 0.01 to 0.6% by weight, the amount of ultraviolet light stabilizer (II) present in the polyolefin is from 0.02 to 0.9% by weight and the amount of light stabilizer (III) present in the polyolefin is from 0.05 to 2.0% by weight.

9. The method according to claim 1, incorporating at least one further stabilizer selected from the group consisting of hindered benzoates, phenolic antioxidants, phosphites and phosphonites and mixtures thereof, in an amount of from 0.001 to 1.5% by weight of the weight of the polyolefin.

10. The method according to claim 9, wherein the further stabilizer is selected from the group consisting of hindered benzoates (VI) of formula VI 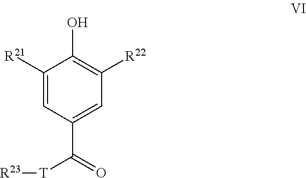
wherein
each of R²¹ and R²² is, independently, chosen from C₁₋₁₂ alkyl,
T represents O or NR²⁴, where R²⁴ is H or C₁₋₃₀ hydrocarbyl,
R²³ is H or C₁₋₃₀ hydrocarbyl.

11. The method according to claim 10, wherein the hindered benzoate (VI) is selected from 2,4-di-tert-butylphenyl 3,5-di-tert-butyl-4-hydroxybenzoate and hexadecyl-3,5-di-tert-butyl-4-hydroxybenzoate, as well as mixtures thereof.

12. A polyolefin film having a thickness of 1 to 350 microns comprising a stabilizing amount of a stabilizer composition comprising
i) at least one o-hydroxyphenyl triazine ultraviolet light absorber (I) selected from 2-(2′-hydroxyphenyl)-1,3,5-triazine compounds according to Formula I: 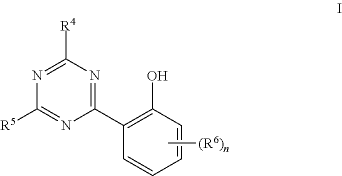
wherein:
each of R⁴ and R⁵ is, independently, chosen from C₆₋₁₀ aryl; or C₆₋₁₀ aryl substituted by one to three of: hydroxyl, halogen, C₁₋₁₂ hydrocarbyl, C₁₋₁₂ alkoxy, C₁₋₁₂ alkoxyester, C₂₋₁₂ alkanoyl, phenyl or by phenyl substituted by one to three of: hydroxyl, halogen, C₁₋₁₂ hydrocarbyl, C₁₋₁₂ alkoxy, C₁₋₁₂ alkoxyester, and C₂₋₁₂ alkanoyl, or by mixtures thereof; or mono- or di-C₁₋₁₂ hydrocarbyl-substituted amino; or C₂₋₁₂ alkanoyl; or C₁₋₁₂ alkyl; or C₁₋₁₂ alkoxy;
n is from 0 to 4; and
R⁶ is a substituent that is the same or different, at from 0 to 4 positions of the 2-hydroxyphenyl portion of Formula I, and is independently chosen from hydroxyl, halogen, C₁₋₁₂ hydrocarbyl, C₁₋₁₂ alkoxy, C₁₋₁₂ alkoxyester, C₂₋₁₂ alkanoyl and phenyl;
ii) at least one ultraviolet light stabilizer selected from tetramethyl-4-piperidinyl compounds (II) according to Formula II 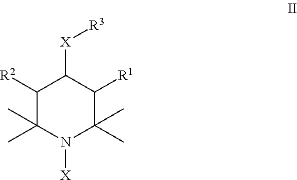
wherein:
X represents a bridging group selected from the group of —O—C(═O)—, —CR′₂—C(═O)—,
—CR′₂—C(═O)—NR′—, —NR′—C(═O)—, —C(═O)—NR′—, —O—, —NR′— or —C(═O)— where each R′, independently, represents H or C₁₋₂₀ hydrocarbyl,
Z represents H, —R, —C(═O)—R or —OR where R is a C₁₋₂₀ hydrocarbyl, said hydrocarbyl being optionally substituted with one or more hydroxyl, C₁₋₃₀ alkoxy or C₂₋₃₀ alkanoyl,
R³ is a C₆₋₃₀ hydrocarbyl, and
each of R¹ and R² is, independently, chosen from H and C₁-C₆ alkyl; and
iii) at least one light stabilizer (III) chosen from hindered amine light stabilizers (HALS) different from compound of formula II,
wherein said polyolefin film provides increased resistance against degradation due to thermal oxidation, light, or the use of agrochemicals.

13. The film according to claim 12, wherein the 2-(2′-hydroxyphenyl)-1,3,5-triazine compound (I) is 4,6-bis-(2,4-dimethylphenyl)-2-(2-hydroxy-4-octyloxyphenyl)-s-triazine.

14. The film according to claim 12, wherein the tetramethyl-4-piperidinyl compounds (II) is selected from compounds of formula IIa 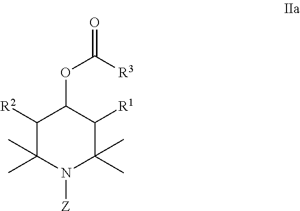
wherein
Z is H, a C₁₋₆ alkyl or —OR where R is a C₁₋₁₀ alkyl optionally substituted with hydroxyl, C₁₋₂₂ alkoxy or C₂₋₂₂ alkanoyl;
R³ is a C₆₋₃₀ alkyl or C₆₋₃₀ alkenyl; and
each of R¹ and R² is, independently, chosen from H and C₁-C₆ alkyl.

15. The film according to claim 12, wherein the tetramethyl-4-piperidinyl compound (II) is selected from those of formula II, IIa, IIb and/or IIc 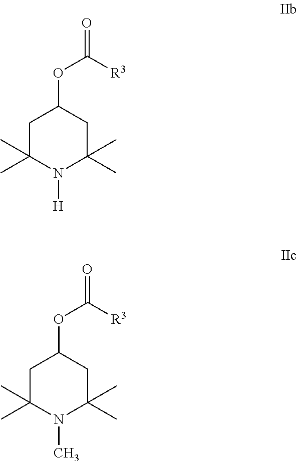
wherein R³ is a C₁₂₋₂₂ alkyl or C₁₂₋₂₂ alkenyl.

16. The film according to claim 12, wherein the tetramethyl-4-piperidinyl compound (II) is selected from 2,2,6,6-tetramethylpiperidin-4-yl-octadecanoate; 2,2,6,6-tetramethylpiperidin-4-yl-hexadecanoate; and mixtures thereof; 1,2,2,6,6-pentamethylpiperidin-4-yl-octadecanoate; 1,2,2,6,6-pentamethylpiperidin-4-yl-hexadecanoate; and mixtures thereof.

17. The film according to claim 12, wherein the hindered amine light stabilizer compound (III) is selected from those comprising at least one molecular fragment according to Formula IV 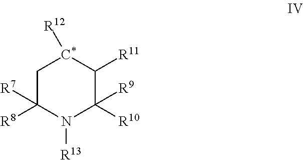
wherein
each of R⁷, R⁸, R9 and R¹⁰ is, independently, chosen from C₁-C₂₀ hydrocarbyl, with the proviso that R⁷ and R⁸ and/or R⁹ and R¹⁰ taken together with the carbon to which they are attached may form a C₅₋₁₀ cycloalkyl;
R¹¹ is chosen from: H and C₁-C₈ hydrocarbyl;
R¹² is chosen from H and C₁-C₈ hydrocarbyl;
R¹³ represents H, —OH, —CH₂CN, C₁₋₂₀ hydrocarbyl, —C(═O)—R or —OR where R is a C₁₋₂₀ hydrocarbyl, said hydrocarbyl being optionally substituted with one or more hydroxyl, C₁₋₃₀ alkoxy or C₂₋₃₀ alkanoyl; and
the molecular fragment is bonded to the rest of the compound via the carbon atom marked * with the proviso that the molecular fragment can form a spiro structure with the rest of the compound so that R¹² does not exist;
and/or to Formula V 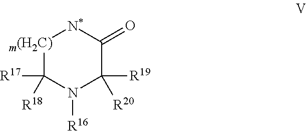
wherein
m is an integer from 1 to 2;
each of R¹⁷, R¹⁸, R¹⁹ and R²⁰ is, independently, chosen from C₁-C₂₀ hydrocarbyl, with the proviso that R¹⁷ and R¹⁸ and/or R¹⁹ and R²⁰ taken together with the carbon to which they are attached may form a C₅₋₁₀ cycloalkyl;
R¹⁶ represents H, —OH, —CH₂CN, C₁₋₂₀ hydrocarbyl, —C(═O)—R or —OR where R is a C₁₋₂₀ hydrocarbyl, said hydrocarbyl being optionally substituted with one or more hydroxyl, C₁₋₃₀alkoxy or C₂₋₃₀ alkanoyl; and
the molecular fragment is bonded to the rest of the compound via the nitrogen atom marked *.

18. The film according to claim 17, wherein the hindered amine light stabilizer (III) is1,6-hexanediamine, N,N′-bis(2,2,6,6-tetramethyl-4-piperidinyl)-, polymers with morpholine-2,4,6-trichloro-1,3,5-triazine reaction products, methylated or a mixture of 1,6-hexanediamine, N,N′-bis(2,2,6,6-tetramethyl-4-piperidinyl)-, polymers with 2,4-dichloro-6-(4-morpholinyl)-1,3,5-triazine and 1,6-hexanediamine, N,N′-bis(2,2,6,6-tetramethyl-4-piperidinyl)-, polymers with morpholine-2,4,6-trichloro-1,3,5-triazine reaction products, methylated.

19. The film according to claim 12, wherein the amount of ultraviolet light stabilizer (I) present in the polyolefin is from 0.01 to 0.6% by weight, the amount of ultraviolet light stabilizer (II) present in the polyolefin is from 0.02 to 0.9% by weight and the amount of light stabilizer (III) present in the polyolefin is from 0.05 to 2.0% by weight.

20. The film according to claim 12, wherein the polyolefin film is made of polyethylene, polypropylene or ethylene based copolymers or mixtures thereof.

21. The film according to claim 12, further comprising at least one further stabilizer selected from the group consisting of hindered benzoates, phenolic antioxidants, phosphites and phosphonites and mixtures thereof, in an amount of from 0.001 to 1.5% by weight of the weight of the polyolefin.

22. The film according to claim 21, wherein the further stabilizer is selected from the group consisting of hindered benzoates (VI) of formula VI 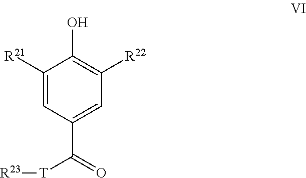
wherein
each of R²¹ and R²² is, independently, chosen from C₁₋₁₂ alkyl,
T represents O or NR²⁴, where R²⁴ is H or C₁₋₃₀ hydrocarbyl,
R²³ is H or C₁₋₃₀ hydrocarbyl.

23. The film according to claim 22, wherein the hindered benzoate (VI) is selected from 2,4-di-tert-butylphenyl 3,5-di-tert-butyl-4-hydroxybenzoate and hexadecyl-3,5-di-tert-butyl-4-hydroxybenzoate, as well as mixtures thereof.
